(19) United States
(12) Patent Application Publication
(10) Pub. No.: US 2026/0150853 A1
(43) Pub. Date: Jun. 4, 2026

(54) METHOD FOR ANTIMICROBIAL TREATMENT OF CAMEL MILK

(71) Applicant: Khalifa University of Science and Technology, Abu Dhabi (AE)

(72) Inventors: Fawzi Banat, Abu Dhabi (AE); Ebrahim Al Hajri, Abu Dhabi (AE); Jahirul Ahmed Mazumder, Abu Dhabi (AE); Abdelmoneim Hassan Abdelmoneim Mohamed, Abu Dhabi (AE)

(21) Appl. No.: 19/078,611

(22) Filed: Mar. 13, 2025

Related U.S. Application Data
(60) Provisional application No. 63/726,860, filed on Dec. 2, 2024.

(51) Int. Cl. A23B 11/16

(52) U.S. Cl. CPC A23B 11/164; A23B 11/162

(57) ABSTRACT

Embodiments include a method for ultraviolet antimicrobial treatment of camel milk. The method includes introducing raw camel milk into a treatment chamber, exposing the raw camel milk to an ultraviolet light source within the treatment chamber, and evacuating treated camel milk from the treatment chamber.

### TECHNICAL FIELD

The subject matter disclosed herein relates to devices and methods for antimicrobial treatment of camel milk.

### BACKGROUND

Camel milk has been consumed for centuries in areas where camels are native, such as the Middle East, North Africa, and some parts of Asia. For decades, pastoralists consumed only fresh camel milk as a gift for hosts. As a result, its selling was frequently frowned upon, and it was not regarded as a commodity. Furthermore, it did not undergo any processing, excluding fermentation, to extend its shelf-life under desert conditions. Camel milk is a relatively new addition to the market, nationally or internationally. A more varied range of dairy products could be marketed due to the camel milk market's growth and the increasing understanding of its exquisite composition and transformation processes. With the availability of recent research, camel milk—a significant product recognized for its purported or real “medicinal” benefits—can now advance past its marginal status. Indeed, the camel milk market is forecasted to grow by US$ 1.88B during 2023-2028, accelerating at a compound annual growth rate of 5.17% during the prediction period.

Camel milk is well-recognized for its exceptional composition and nutritional aspects, making it an interesting substitute for bovine milk. It has attracted attention in the global market, and the demand for camel milk products has increased due to potential health aspects. As a result, camel dairies have been established in several countries, with certain products accessibility, such as pasteurized milk, cheese, yogurt, and milk chocolates. The growing consumer interest and unique properties of camel milk make it a fascinating role market within the dairy industries. The nutritional profile of camel milk is vital in the worldwide camel dairy market. Its richness in proteins, minerals (calcium, potassium, and iron), and vitamins (B, C, and E) makes it a nutritious dairy alternative. Accordingly, camel milk is a convincing choice for individuals seeking healthy and functional foods. The lower cholesterol content in camel milk is also attractive for consumers.

It is known that traditional heat treatments cause chemical alterations of milk components, including denaturation of protein, loss of flavors and vitamins, nonenzymatic browning, and depression at freezing point, which might cause adverse variations in nutritional value, flavor, and color of milk. Heat processing is applied to guarantee a high safety level and shelf-life extension for dairy products. The heat treatment includes thermization (57-68° C. for 5-30 seconds), low-temperature long-time (63-66° C. for 30 min), high-temperature long-time (72° C. for 15 seconds), in-container sterilization at 110-115° C. for 10-20 min, and sterilization at ultra-high temperature (UHT) (130-140° C. for 3-5 seconds). Pasteurized and thermized milk are distributed in chilled conditions at 4-6° C., and high-temperature long-time pasteurized milk can be stored in a refrigerator for 10-14 days. UHT-treated milk may be stored at ambient temperature and can be kept for 6 months. Pasteurization inhibits psychotropic bacteria; however, heat-resistant extracellular enzymes (lipases and proteases) retain their activity throughout processing and storage, which might cause degradation of the treated product, including flavor defects and technological problems such as gelation and sedimentation.

Pasteurization is commonly employed with camel milk. However, the conditions of pasteurization applied by each holder are regularly decided without considering camel milk specificity, with the conditions being mostly based on the standards adjusted for bovine milk pasteurization. The reported conditions for camel milk pasteurization in the literature are fairly variable (60° C./30 min; 75° C./15 min; 63° C./30 min). Simultaneously, several private companies in the United Arab Emirates (UAE), Morocco, Algeria, Tunisia, Saudi Arabia, Mauritania, Kazakhstan, and Niger produce pasteurized camel milk. All of these companies apply different conditions for pasteurization. It is worth noting that regional/national/international standards for camel milk have not yet been established or have been adopted from bovine milk. In some countries, no standards are set by the authorities, or at least, it is proposed to use the same conditions applied for bovine milk pasteurization. UV irradiation has been previously utilized only or solid foods. The US Food and Drug Administration (FDA) and the US Department of Agriculture (USDA) has approved for use in liquid foods as an alternative to heat pasteurization. UV treatment has the benefits of low costs of installation, operation, maintenance, and energy usage. UV treatment also provides the benefits of preserving the textural, nutritional, and sensory attributes of the milk, not generating waste heat, producing no toxins or chemical residues, and it can be applied with other processing methodologies for synergistic or additive effects. Nevertheless, it has restrictions for use in opaque or cloudy liquids such as milk because of its low penetrating power. Also, prolonged exposure to UV might cause damage to humans (skin cancer, burns, eyes).

### SUMMARY

In some aspects, the techniques described herein relate to a method for ultraviolet antimicrobial treatment of camel milk, including the steps of:
introducing raw camel milk into a treatment chamber;
exposing the raw camel milk to an ultraviolet light source within the treatment chamber; and
evacuating treated camel milk from the treatment chamber.

In some aspects, the techniques described herein relate to a method for ultrasonic antimicrobial treatment of camel milk, including the steps of:
introducing raw camel milk into a treatment chamber;
subjecting the raw camel milk to ultrasonic vibrations within the treatment chamber; and
evacuating treated camel milk from the treatment chamber.

### BRIEF DESCRIPTION OF THE DRAWINGS

FIG. 1 is a schematic diagram of a system for antimicrobial treatment of camel milk using ultraviolet light according to some embodiments.

FIG. 2 is a flow chart of a method for antimicrobial treatment of camel milk using ultraviolet light according to some embodiments.

FIG. 3 is a schematic diagram of a system for antimicrobial treatment of camel milk using ultrasonic vibrations according to some embodiments.

FIG. 4 is a flow chart of a method for antimicrobial treatment of camel milk using ultrasonic vibrations according to some embodiments.

### DETAILED DESCRIPTION

The present disclosure describes system and method for antimicrobial treatment of camel milk using ultraviolet light and/or ultrasonic vibrations.

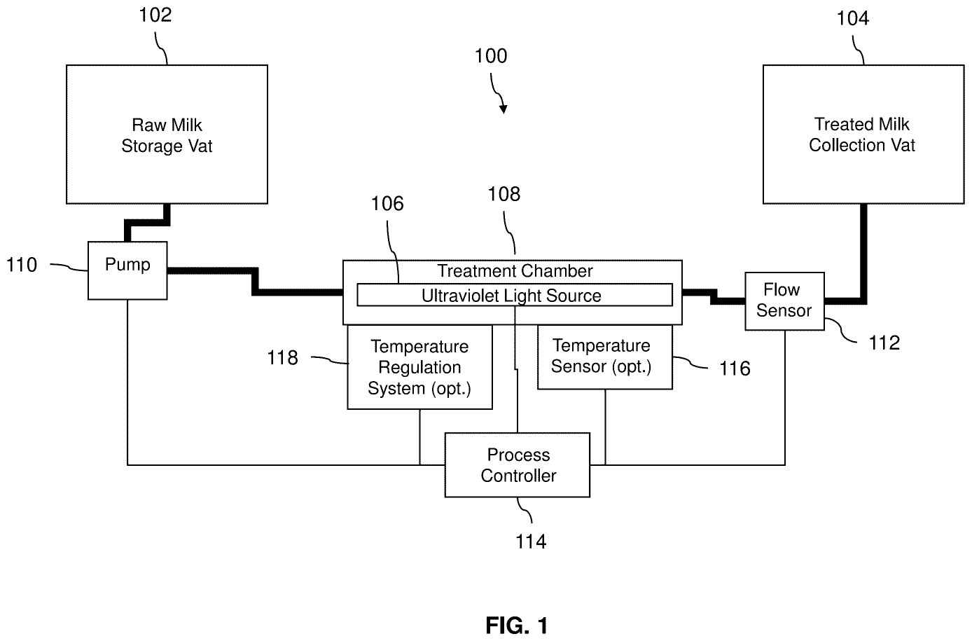

FIG. 1 is a schematic diagram of a system 100 for antimicrobial treatment of camel milk using ultraviolet light. The system 100 includes a first vat 102 for the storage of raw, untreated camel milk and a second vat 104 for the collection of treated milk after exposure to ultraviolet light generated by an ultraviolet light source 106 within a treatment chamber 108. The milk is moved from the first vat 102, through the treatment chamber 108, and into the second vat 104 by a pump 110 or other fluid movement device. In an alternative embodiment, the milk may be moved from the first vat 102, through the treatment chamber 108, and into the second vat 104 by a gravity induced flow. A flow rate of the pump 110 is preferably monitored by a flow sensor 112 and controlled by a process controller 114 to ensure adequate and consistent exposure of the camel milk to the ultraviolet light generated by the ultraviolet light source 106 within the treatment chamber 108. The flow rate of the pump 110 is preferably set so that the raw camel milk is exposed to the ultraviolet light source 106 within the treatment chamber 108 for at least 1.68 to 1.92 minutes.

The ultraviolet light source 106 provides ultraviolet light in the UV-C band having a wavelength in the range of 200-280 nanometers (nm). The ultraviolet light source 106 has a peak emission energy at about 254 nm. The ultraviolet light source 106 preferably has an intensity in the range of 4.1 to 5.5 milliwatts per square centimeter within the treatment chamber 108.

The system 100 may optionally include a temperature sensor 116 and a temperature regulation system 118, e.g. a refrigeration unit, interfacing with the process controller 114 to maintain a desired temperature of the various components of the system 100.

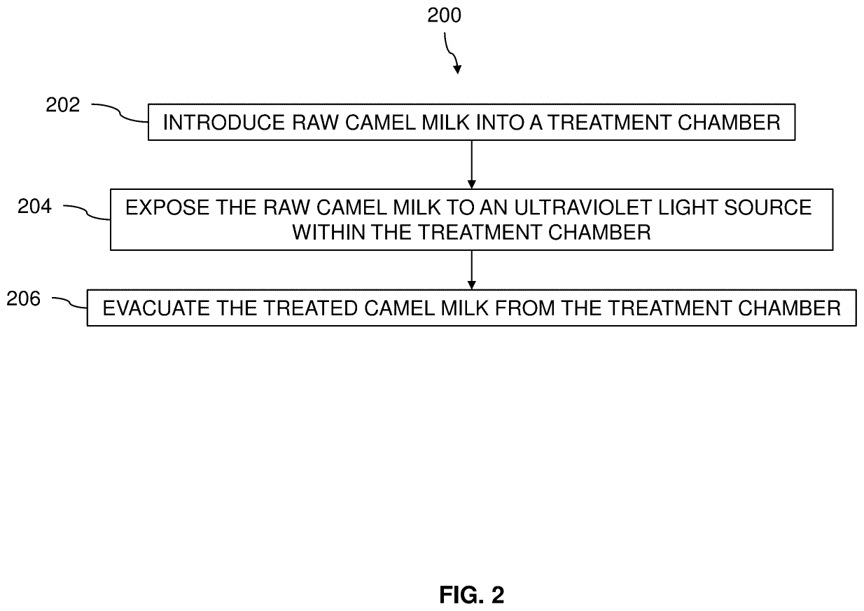

FIG. 2 is a flow chart of a method 200 for ultraviolet antimicrobial treatment of camel milk, for example using the system 100. This method 200 includes step 202 in which raw camel milk is withdrawn from a first vat 102 in which raw camel milk is stored and introducing the raw camel milk into a treatment chamber 108. The method 200 also includes step 204 in which the raw camel milk is exposed to an ultraviolet light source 106 within the treatment chamber 108. The method 200 further includes step 206 in which treated camel milk is evacuated from the treatment chamber 108 and collected in a second vat 104.

In the method 200, raw camel milk is continually introduced into the treatment chamber 108 and treated camel milk may be continually evacuated from the treatment chamber 108 due to the action of the pump 110. Introduction of camel milk into the treatment chamber 108 and evacuation of camel milk from the treatment chamber 108 is preferably performed at a constant flow rate in order to obtain consistent treatment of the raw camel milk. This constant flow rate may be obtained by monitoring the flow into or out of the treatment chamber 108 using a flow sensor 112 while controlling the flow through the pump 110 using a process controller 114 communicating with the flow sensor 112. The flow rate of the pump is preferably set so that the raw camel milk is exposed to the ultraviolet light source 106 within the treatment chamber 108 for at least 1.68 to 1.92 minutes. In another embodiment, the milk may be exposed for about 1.5 to about 3 minutes, about 1 to 4 minutes, about 1.7 to about 1.8 minutes, or about 1.6 to about 2 minutes.

The method 200 may optionally include regulating the temperature of the system 100 using a temperature sensor and a temperature regulation system, e.g., a refrigeration unit, interfacing with the process controller to maintain a desired temperature of the various components of the system 100. The method 200 is preferably conducted at a temperature of about 20° C. In another embodiment, the temperature may be in the range of about 15-25° C.

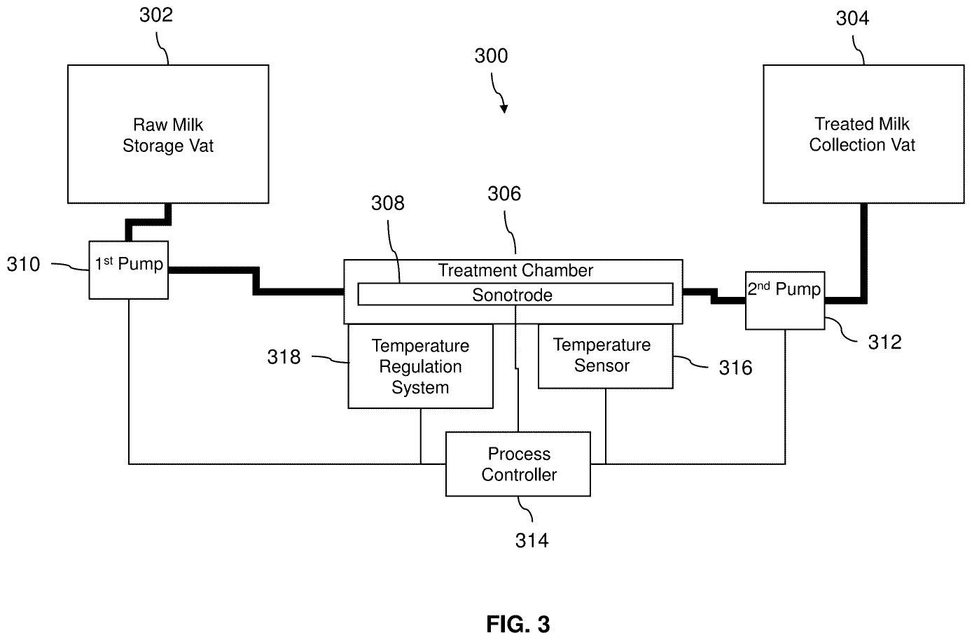

FIG. 3 is a schematic diagram of a system 300 for antimicrobial treatment of camel milk using ultrasonic vibration. The system 300 includes a first vat 302 for the storage of raw, untreated camel milk and a second vat 304 for the collection of treated milk after subjecting the raw camel milk to ultrasonic vibration within a treatment chamber 306 using a sonotrode 308. The milk is moved from the first vat 302 to the treatment chamber 306, and into the second vat 304 by a first pump 310 or other fluid movement device. Following treatment, the milk is moved from the treatment chamber 306 to the second vat 304 by a second pump 312. Operation of the first and second pumps 310, 312 is preferably controlled by a process controller 314 to ensure adequate and consistent exposure of the camel milk to the ultrasonic vibrations generated by the sonotrode 308 within the treatment chamber 306. The raw camel milk is exposed to the ultrasonic vibrations within the treatment chamber 306 for about 10 minutes. In another embodiment, the time may be about 5 minutes to about 15 minutes. In an alternative embodiment, the milk may be moved from the first vat 302 to the treatment chamber 306 and from the treatment chamber 306 into the second vat 304 by a gravity induced flow where the first and second pumps 310, 312 are replaced by valves.

The ultrasonic vibrations preferably have a frequency of about 20 kHz (within typical tolerances) and a power of about 750 watts.

The system 300 includes a temperature sensor 316 and a temperature regulation system 318, e.g. a refrigeration unit, interfacing with the process controller to maintain a desired temperature of the treatment chamber 306 due to heat generated in the camel milk by the ultrasonic vibrations generating localized heat due to cavitation effects, when microscopic bubbles formed by the ultrasonic vibrations collapse and release energy, leading to a rise in temperature of the camel milk being treated in the treatment chamber 306.

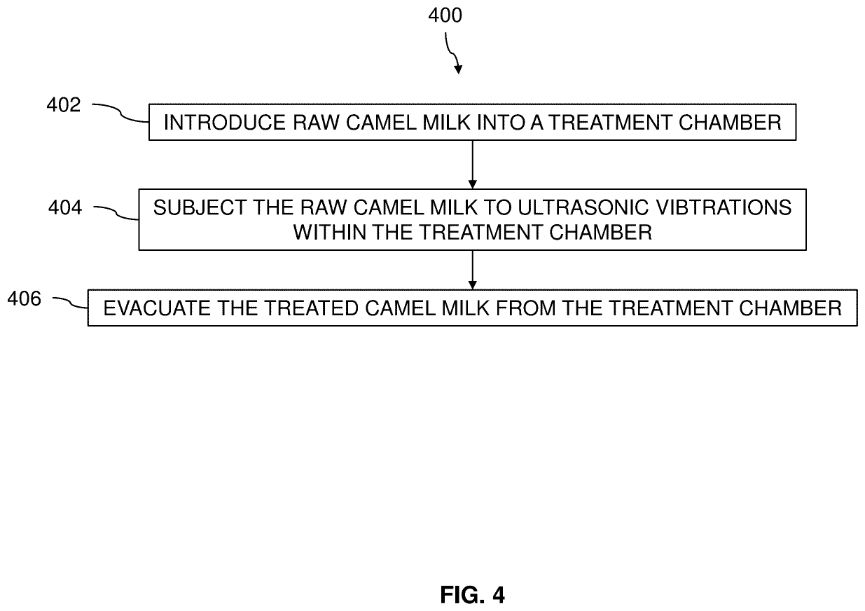

FIG. 4 is a flow chart of a method 400 for ultrasonic antimicrobial treatment of camel milk, for example using the system 300. This method 400 includes step 402 in which raw camel milk is withdrawn from a first vat 302 in which raw camel milk is stored and the raw camel milk is introduced into a treatment chamber 306. The method 400 also includes step 404 in which the raw camel milk is subjected to ultrasonic vibrations within the treatment chamber 306 generated by a sonotrode 308. The method 400 further includes step 406 in which treated camel milk is evacuated from the treatment chamber 306 and collected in a second vat 304.

In the method 400, the camel milk is preferably treated in a batch process rather than a continuous process. The treatment chamber 306 is filled with raw camel milk from the first vat 302 and then treated by subjecting the milk to ultrasonic vibrations. The treated milk is then drained from the treatment chamber 306 to the second vat. Introduction of camel milk into the treatment chamber 306 and evacuation of camel milk from the treatment chamber 306 is preferably performed at a constant flow rate in order to obtain consistent treatment of the raw camel milk. The raw camel milk is subjected to the ultrasonic vibrations within the treatment chamber 306 for about 10 minutes. In another embodiment, the time may be between about 5 and about 15 minutes.

The sonotrode is configured to provide ultrasonic vibrations operates at a frequency of 20 kHz and provides a power of about 750 watts. The ultrasonic vibrations may be applied in a pulsed mode with a 50% duty cycle for a period of at least 10 minutes. Each duty cycle may last 20 seconds and includes 10 seconds of applying the ultrasonic vibrations followed by 10 seconds of not the applying ultrasonic vibrations.

The method 400 may include regulating the temperature of the treatment chamber 306 using a temperature sensor 316 and a temperature regulation system 318, e.g., a refrigeration unit, interfacing with the process controller 314 to maintain a desired temperature within the treatment chamber 306. The method 400 is preferably conducted at a temperature of about 20° C.

To fully understand the effectiveness of ultraviolet and ultrasonic treatment of camel milk, it is essential to assess its impact on both the nutritional value and the longevity of the milk. The inventors found that ultraviolet treatment provided superior effectiveness in microbial load inhibition of camel milk even after one cycle (3-log reduction, 99.9%). Other treatments, including ultrasonic treatment, also achieved the standard microbial inhibition at 70% amplitude for 20 min and a power of 50% for 30 s, respectively. The chemical composition of camel milk was not significantly affected by UV treatment compared to thermal pasteurization, ultrasonication, and microwave. The activity of phosphatase and lactate dehydrogenase enzymes was also determined before and after processing. Furthermore, the mineral profile in camel milk was evaluated before and after ultraviolet and ultrasonic treatment. The nutrient and various bioactive contents in camel milk were insignificantly affected by ultraviolet and ultrasonic as compared to thermal pasteurization.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment(s) disclosed, but that the invention will include all embodiments falling within the scope of the appended claims.

### Discussion of Possible Embodiments

The following are non-exclusive descriptions of possible embodiments of the present invention.

In some aspects, the techniques described herein relate to a method for ultraviolet antimicrobial treatment of camel milk, including introducing raw camel milk into a treatment chamber, exposing the raw camel milk to an ultraviolet light source within the treatment chamber, and evacuating treated camel milk from the treatment chamber.

The method of the preceding paragraph can optionally include, additionally and/or alternatively any, one or more of the following features/steps, configurations and/or additional components.

In some aspects of the method, the raw camel milk is continually introduced into the treatment chamber and the treated camel milk is continually evacuated from the treatment chamber.

In some aspects of the method, introduction of camel milk into the treatment chamber and evacuation of camel milk from the treatment chamber is performed at a constant flow rate.

In some aspects of the method, the ultraviolet light source provides ultraviolet light in the UV-C band having a wavelength in a range of 200-280 nanometers (nm).

In some aspects of the method, the ultraviolet light source has a peak energy emission at about 254 nm.

In some aspects of the method, the ultraviolet light source has an intensity in a range of 4.1 to 5.5 milliwatts per square centimeter.

In some aspects of the method, the flow rate allows the raw camel milk to be exposed to the ultraviolet light source for at least 1.68 to 1.92 minutes.

In some aspects of the method, a temperature of the treatment chamber is maintained in a range of 18 to 22° C.

In some aspects of the method, a temperature of the treatment chamber is maintained at 20° C.

In some aspects, the techniques described herein relate to a method for ultrasonic antimicrobial treatment of camel milk, including introducing raw camel milk into a treatment chamber, subjecting the raw camel milk to ultrasonic vibrations within the treatment chamber, and evacuating treated camel milk from the treatment chamber.

The method of the preceding paragraph can optionally include, additionally and/or alternatively any, one or more of the following features/steps, configurations and/or additional components.

In some aspects of the method, the raw camel milk is continually introduced into the treatment chamber and the treated camel milk is continually evacuated from the treatment chamber.

In some aspects of the method, introduction of camel milk into the treatment chamber and evacuation of camel milk from the treatment chamber is performed at a constant flow rate.

In some aspects of the method, the ultrasonic vibrations have a frequency of about 20 kHz.

In some aspects of the method, the raw camel milk is subjected to the ultrasonic vibrations in a pulsed mode with a 50% duty cycle for a period of at least 10 minutes.

In some aspects of the method, each duty cycle lasts 20 seconds and includes 10 seconds of applying the ultrasonic vibrations followed by 10 seconds of not the applying ultrasonic vibrations.

In some aspects of the method, the ultrasonic vibrations have a power of about 750 watts.

In some aspects of the method, the flow rate allows the raw camel milk to be subjected to the ultrasonic vibrations for about 10 minutes.

In some aspects of the method, a temperature of the treatment chamber is maintained in a range of 18 to 22° C.

In some aspects of the method, a temperature of the treatment chamber is maintained at 20° C.

1. A method for ultraviolet antimicrobial treatment of camel milk, comprising:
introducing raw camel milk into a treatment chamber;
exposing the raw camel milk to an ultraviolet light source within the treatment chamber; and
evacuating treated camel milk from the treatment chamber.

2. The method according to claim 1, wherein the raw camel milk is continually introduced into the treatment chamber and the treated camel milk is continually evacuated from the treatment chamber.

3. The method according to claim 2, wherein introduction of camel milk into the treatment chamber and evacuation of camel milk from the treatment chamber is performed at a constant flow rate.

4. The method according to claim 3, wherein the ultraviolet light source provides ultraviolet light in the UV-C band having a wavelength in a range of 200-280 nanometers (nm).

5. The method according to claim 4, wherein the ultraviolet light source has a peak emission energy at about 254 nm.

6. The method according to claim 4, wherein the ultraviolet light source has an intensity in a range of 4.1 to 5.5 milliwatts per square centimeter.

7. The method according to claim 6, wherein the flow rate allows the raw camel milk to be exposed to the ultraviolet light source for at least 1.68 to 1.92 minutes.

8. The method according to claim 1, wherein a temperature of the treatment chamber is maintained in a range of 18 to 22°C.

9. The method according to claim 8, wherein a temperature of the treatment chamber is maintained at 20°C.

10. A method for ultrasonic antimicrobial treatment of camel milk, comprising:
introducing raw camel milk into a treatment chamber;
subjecting the raw camel milk to ultrasonic vibrations within the treatment chamber; and
evacuating treated camel milk from the treatment chamber.

11. The method according to claim 10, wherein the raw camel milk is continually introduced into the treatment chamber and the treated camel milk is continually evacuated from the treatment chamber.

12. The method according to claim 11, wherein introduction of camel milk into the treatment chamber and evacuation of camel milk from the treatment chamber is performed at a constant flow rate.

13. The method according to claim 12, wherein the ultrasonic vibrations have a frequency of about 20 kHz.

14. The method according to claim 12, wherein the raw camel milk is subjected to the ultrasonic vibrations in a pulsed mode with a 50% duty cycle for a period of at least 10 minutes.

15. The method according to claim 14, wherein each duty cycle lasts 20 seconds and includes 10 seconds of applying the ultrasonic vibrations followed by 10 seconds of not the applying ultrasonic vibrations.

16. The method according to claim 12, wherein the ultrasonic vibrations have a power of about 750 watts.

17. The method according to claim 16, wherein the flow rate allows the raw camel milk to be subjected to the ultrasonic vibrations for about 10 minutes.

18. The method according to claim 10, wherein a temperature of the treatment chamber is maintained in a range of 18 to 22°C.

19. The method according to claim 18, wherein a temperature of the treatment chamber is maintained at 20°C.
